(19) United States
(12) Patent Application Publication
(10) Pub. No.: US 2009/0161073 A1
(43) Pub. Date: Jun. 25, 2009

(54) Projection display apparatus

(75) Inventors: Tatsuru Kobayashi, Yokohama-shi (JP); Akio Hayama, Yokohama-shi (JP); Kouichi Kawamura, Yokohama-shi (JP); Ryo Nishima, Yokohama-shi (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Victor Company of Japan, Ltd., Yokohama-shi (JP)

(21) Appl. No.: 12/316,785

(22) Filed: Dec. 16, 2008

(30) Foreign Application Priority Data
Dec. 19, 2007 (JP) JP 2007-326992
Sep. 4, 2008 (JP) JP 2008-226855

(51) Int. Cl. G03B 21/14

(52) U.S. Cl. 353/20; 353/31

(57) ABSTRACT

A bundle of rays is incident in a lens array and converted into sub-bundles of rays. The sub-bundles of rays are separated by a color separator into first and second sub-bundles of rays of different colors. The first and the second sub-bundles of rays are combined by other lens arrays into a first and a second bundle of rays of uniform illuminance, respectively. The first and second bundle of rays of uniform illuminance are applied polarization beam splitting and then polarization angle conversion by polarization converters, to be converted into first and second linearly polarized beams, respectively. The second linearly polarized beams are separated by a color separator, provided on an optical path of the second linearly polarized beams, into third and fourth linearly polarized beams of different colors. The first, third and fourth linearly polarized beams are modulated by liquid crystal display devices, provided on optical paths of the first, third and fourth linearly polarized beams, respectively, with input video signals into first, second and third modulated beams. The first, second and third modulated beams are combined by a color combiner into a combined bundle of rays to be projected for displaying images carried by the video signals.

### CROSS-REFERENCE TO RELATED APPLICATIONS

This application is based on and claims the benefit of priority from the prior Japanese Patent Application Nos. 2007-326992 filed on Dec. 19, 2007, and 2008-226855 filed on Sep. 4, 2008, the entire contents of which is incorporated herein by reference.

### BACKGROUND OF THE INVENTION

The present invention relates to a projection display apparatus that exhibits high color reproducibility with less damage to optical components against a high-intensity light source.

One of the known projection display apparatuses equipped with reflective liquid crystal display devices is a projection display apparatus equipped with polarization converters that exhibits high light utilization efficiency with a comparatively simple structure.

Such a projection display apparatus equipped with polarization converters is disclosed in Japanese unexamined Patent Application Publication No. 2000-321662 (referred to as Citation 1, hereinafter).

In the disclosed display apparatus, among light components emitted from a light source, light components in ultraviolet- and infrared-ray ranges are eliminated by filters, and the remaining components are incident on an integrator optical system including polarization converters.

FIG. 1 shows a schematic illustration of an optical system of a projection display apparatus 100 disclosed in Citation 1.

Emitted from a light source 101 is a bundle of roughly parallel rays. The rays are incident on an infrared-ray reflection filter 102. The infrared (RF) rays involved in the incident rays are reflected by the filter 102 and hence eliminated from the incident rays. The rays that have passed through the filter 102 are incident on an ultraviolet-ray reflection filter 103. The ultraviolet (UV) rays involved in the incident rays are reflected by the filter 103 and hence eliminated from the incident rays.

The rays passing through the ultraviolet-ray reflection filter 103 constitute white light with no infrared and ultraviolet rays. The white light passes through a fly-eye lens system 104 and is incident on a polarization converter 105, by which it is converted from randomly polarized beams into linearly polarized beams.

Typically, a polarization film is used for converting randomly polarized beams into linearly polarized beams, the usage of which is, however, not efficient because it eliminates almost half of the polarized beams.

In contrast, the polarization converter 105 that consists of a polarization beam splitter and a half wave plate can utilize almost all the incident light beams by converting P-polarized light beams into S-polarized light beams.

The white light thus converted into linearly polarized beams by the polarization converter 105 is subjected to color separation by a cross dichroic mirror 106, by which it is separated into a blue ray (referred to as a B-ray, hereinafter) and a yellow ray (referred to as a Y-ray, hereinafter). The Y-ray is incident on a dichroic mirror 107, by which it is separated into a green ray (referred to as a G-ray, hereinafter) and a red ray (referred to as a R-ray, hereinafter).

The R-, G- and B-rays obtained by color separation at a color-separation optical system that consists of the cross dichroic mirror 106 and the dichroic mirror 107 are incident on polarization beam splitters 108r, 108g and 108b, respectively, each provided on an optical path of respective rays. S-polarized light beams of the R-, G- and B-rays are reflected by polarized-light separating sections of the splitters 108r, 108g and 108b, respectively. The reflected beams are incident on reflective liquid crystal display devices 109r, 109g and 109b for R-, G- and B-rays, respectively.

The R-, G- and B-rays (the S-polarized light beams) incident on the reflective liquid crystal display devices 109r, 109g and 109b, respectively, are subjected to modulation with drive signals for the colors R, G, and B, respectively. Some of the S-polarized light beams of each ray are modulated into P-polarized light beams whereas the others remain unchanged as the S-polarized light beams, depending on the modulation. Mixed lights of the P- and S-polarized light beams of the R-, G- and B-rays are reflected by and emitted from the reflective liquid crystal display devices 109r, 109g and 109b, respectively.

The mixed lights of the P- and S-polarized light beams of the R-, G- and B-rays are incident on the polarization beam splitters 108r, 108g and 108b, respectively, and the P-polarized light beams (obtained by the modulation described above) only pass through the polarized-light separating sections of the respective polarization beam splitters.

The P-polarized light beams of the R-, G- and B-rays are then incident on a cross dichroic prism 110 (a color-synthesis optical system) at different light incident surfaces for respective colors and subjected to color synthesis.

The light obtained by the color synthesis is emitted from the cross dichroic prism 110. The emitted light is enlarged by a projection lens 111 and projected onto a screen (not shown) for displaying a color image.

Such an emitted light from a projection display apparatus requires high brightness for use in projection of images onto a large screen in movie theaters, large-scale commercial facilities, etc., in order to have enlarged images with no decrease in illumination per unit of area to be projected.

There are three known technical factors in obtaining higher brightness for images to be projected from a projection display apparatus: (1) a larger size of a liquid crystal display device; (2) a smaller F-number for an optical system; and (3) a higher intensity for a light source.

The technical factors (1) and (2) require a larger liquid crystal display device which results in higher production cost and a drastic modification to optical design.

In contrast, the technical factor (3) requires a smaller modification to optical design with replacement of the light source only, thus being advantageous in obtaining a higher brightness for projected images. High intensity can be is easily achieved for projection display apparatuses with a xenon lamp, already in practical use, with a higher nominal input from 1 KW to 10 KW than 300 W for an extra-high pressure mercury lamp used in general projection display apparatuses.

The reliability of optical components is, however, one big issue for the technical factor (3).

For example, optical components, such as, a polarizer, a wave plate, and a polarization converter suffer lower reliability when light of a high intensity is incident thereon. This is because an organic material used for such optical components is degraded by light of high intensity.

Major causes of degradation of such optical components are oxidation and a photochemical reaction. The degradation due to each of the oxidation and photochemical reaction is triggered by a higher optical or thermal energy in response to the change in wavelength of light incident on an optical component. A higher optical energy is caused by a shorter light wavelength as becoming closer to the ultra-violet range. In contrast, a higher thermal energy is caused by a longer light wavelength as becoming closer to the infrared range.

During each of the oxidation and photochemical reaction, light incident on an organic material causes disruption of the chemical bonding between polymers that constitute the organic material. The disruption leads to occurrence of clacks or color change, such as, turning yellow.

The degradation of optical components discussed above is accelerated if the optical and thermal energies are applied to an organic material at the same time due to the oxidation and photochemical reaction.

Such degradation leads to change in transmittance and reflectivity, and also change in polarized state of light for optical components, such as, a polarizer, a wave plate, and a polarization converter, for which an organic material is used.

In order to avoid such a problem of degradation, the projection display apparatus 100, shown in FIG. 1, is equipped with a cooling means (not shown) for cooling the polarization converter 105, even though the known apparatus 100 is not so high power. Because the converter 105 is located as closer to the light source 101, and hence suffers a high temperature due to a bundle of rays being focused thereon.

However, if a light source of high intensity is used instead of the light source 101, it emits more intense light to half wave plates and prisms that constitute the polarization converter 105. In detail, such intense light is incident on the half wave plates made of polycarbonate that is an organic material and an ultraviolet curable adhesive that is also an organic material and used for bonding between the half wave plates and prisms, and also between the prisms. The incident intense light then promotes the oxidation and photochemical reaction to the organic materials, thus causing lower optical performance, which results in lower reliability of the projection display apparatus 100.

Moreover, in the projection display apparatus 100, a bundle of rays in a wide wavelength range covering a short to a long range of about 400 nm to 700 nm, respectively, are incident on the polarization converter 105 from the light source 101. Incidence of light in such a wide wavelength range promotes the oxidation and photochemical reaction and accelerates the degradation of the organic material used for the converter 105.

Such problems discussed above cause adverse effects to projected images, such as, lower brightness, variation in brightness, and color unevenness or irregularity, on a screen.

Moreover, the known projection display apparatus 100 have several disadvantages as discussed below.

A first disadvantage lies in the difficulty in adjustments to the spectral characteristics of the polarization converter 105 to all of the wavelength ranges in a wide range of a bundle of rays to be incident on the converter 105. This is because the spectral characteristics of the converter 105 is optimized with adjustments to the film thickness of layered dielectric films. Such difficulty in the spectral-characteristics adjustments restricts adjustments to the chromaticity points for the colors R, G and B, for a wider color reproduction range.

A second disadvantage lies in the difference in location of the focal points for the colors R, G and B due to chromatic aberration which is caused by a wide range of a bundle of rays to be incident on the integrator optical system. The integrator optical system is constituted by the fly-eye lens system 104 and the polarization converter 105, as shown in FIG. 1. Such difference in location of the focal points causes difference in the illuminated zones of the reflective liquid crystal display devices 109r, 109g and 109b for the colors R, G and B, respectively.

Another disadvantage lies in the single fly-eye lens system 104. The single system allows the instability of the light source 101 to directly affect the projected light which results in low-quality images on a screen.

A further disadvantage lies in the placement of the polarization converter 105 as closer to the light source 101. Such placement requires a larger converter 105 having several beam splitters integrated into an array with bonding, with half wave plates bonded to a part of the array, which results in a higher production cost.

### SUMMARY OF THE INVENTION

A purpose of the present invention is to provide a compact projection display apparatus that can produce high-quality projected images in a wider color reproduction range, with lower degradation of optical components against optical and thermal energies to be applied thereto.

The present invention provides a projection display apparatus comprising: a light source to emit a bundle of rays; a first lens array via which the bundle of rays is converted into a plurality of sub-bundles of rays; a first color separator to separate the sub-bundles of rays emitted from the first lens array into first and second sub-bundles of rays of a first and a second color, respectively, the first and second sub-bundles of rays being emitted in different directions; a second and a third lens array via which the first and the second sub-bundles of rays are combined into a first and a second bundle of rays of uniform illuminance, respectively; a first and a second polarization converter to apply polarization beam splitting and then polarization angle conversion to the first and second-bundle of rays of uniform illuminance, respectively, to convert the first and second bundle of rays of uniform illuminance into first and second linearly polarized beams, respectively; a second color separator, provided on an optical path of the second linearly polarized beams, to separate the second linearly polarized beams into third and fourth linearly polarized beams of different colors, the third and fourth linearly polarized beams being emitted in different directions; liquid crystal display devices, provided on optical paths of the first, third and fourth linearly polarized beams, respectively, to modulate the first, third and fourth linearly polarized beams with input video signals into first, second and third modulated beams, respectively; and a color combiner to combine the first, second and third modulated beams into a combined bundle of rays to be projected for displaying images carried by the video signals.

Moreover, the present invention provides a projection display apparatus comprising: a light source to emit a bundle of rays; a first color separator to separate the bundle of rays emitted from the light source into first and second bundle of rays of a first and a second color, respectively, the first and second bundle of rays being emitted in different directions; a first and a second integrator optical system via which the first and the second bundle of rays are processed as exhibiting uniform illuminance; a first and a second polarization converter to apply polarization beam splitting and then polarization angle conversion to the first and second bundle of rays of uniform illuminance, respectively, to convert the first and second bundle of rays of uniform illuminance into first and second linearly polarized beams, respectively; a second color separator, provided on an optical path of the second linearly polarized beams, to separate the second linearly polarized beams into third and fourth linearly polarized beams of different colors, the third and fourth linearly polarized beams being emitted in different directions; liquid crystal display devices, provided on optical paths of the first, third and fourth linearly polarized beams, respectively, to modulate the first, third and fourth linearly polarized beams with input video signals into first, second third modulated beams, respectively; and a color combiner to combine the first, second and third modulated beams into a combined bundle of rays to be projected for displaying images carried by the video signals.

Furthermore, the present invention provides a projection display apparatus comprising: a light source to emit a bundle of rays; a first color separator to separate the bundle of rays emitted from the light source into first and second bundle of rays of a first and a second color, respectively, the first and second bundle of rays being emitted in different directions; a first lens array, provided on an optical path of the separated first bundle of rays, via which the separated first bundle of rays is converted into a plurality of first sub-bundles of rays; a second lens array, provided on an optical path of the first sub-bundle of rays, via which the first sub-bundles of rays are combined into a first bundle of rays of uniform illuminance; a first polarization converter, provided on an optical path of the first bundle of rays of uniform illuminance, to apply polarization ray splitting and then polarization angle conversion to the first bundle of rays of uniform illuminance to convert the first bundle of rays of uniform illuminance into first linearly polarized beams; a first liquid crystal display device, provided on an optical path of the first linearly polarized beams, to modulate the first linearly polarized beams with input video signals into first modulated beams; a third lens array, provided on an optical path of the separated second bundle of rays, via which the separated second bundle of rays is converted into a plurality of second sub-bundles of rays; a second color separator, provided on an optical path of the second sub-bundles of rays, to separate the second sub-bundle of rays into third and fourth bundle of rays of different colors, the third and fourth bundle of rays being emitted in different directions; a fourth and a fifth lens array, provided on optical paths of the third and fourth bundle of rays, respectively, via which the third and fourth sub-bundles of rays are combined into a third and a fourth bundle of rays of uniform illuminance, respectively; a second and a third polarization converter, provided on optical paths of the third and fourth bundle of rays of uniform illuminance, respectively, to apply polarization beam splitting and then polarization angle conversion to the third and fourth bundle of rays of uniform illuminance, respectively, to convert the third and fourth bundle of rays of uniform illuminance into third and fourth linearly polarized beams, respectively; a second and a third crystal display device, provided on optical paths of the third and fourth linearly polarized beams, respectively, to modulate the third and fourth linearly polarized beams with input video signals into second and third modulated beams, respectively; and a color combiner to combine the first, second and third modulated beams into a combined bundle of rays to be projected for displaying images carried by the video signals.

The term “a bundle of rays” defined by the appended claims may be interpreted as “luminous flux”. Moreover, the term “ray” defined by the appended claims is referred to as “beam” when polarization is concerned.

### BRIEF DESCRIPTION OF DRAWINGS

FIG. 1 shows a schematic illustration of an optical system of a known projection display apparatus;

FIG. 2 shows a schematic illustration of an optical system of a projection display apparatus, as a first preferred embodiment of the present invention;

FIG. 3 shows the spectrum of a xenon lamp used in the present invention;

FIG. 4 shows the mechanism of polarization conversion performed by polarization converters used in the present invention;

FIG. 5 shows a schematic illustration of an optical system of a projection display apparatus, as a second preferred embodiment of the present invention;

FIG. 6 shows a schematic illustration of an optical system of a projection display apparatus, as a third preferred embodiment of the present invention;

FIG. 7 shows a schematic illustration of an optical system of a projection display apparatus, as a fourth preferred embodiment of the present invention; and

FIG. 8 shows a schematic illustration of an optical system of a projection display apparatus, as a fifth preferred embodiment of the present invention.

### DETAILED DESCRIPTION OF PREFERRED EMBODIMENTS

Several preferred embodiments according to the present invention will be disclosed with reference to the attached drawings.

In the following description, the term “a bundle of rays” may be interpreted as “luminous flux”. Moreover, the term “ray” is referred to as “beam” when polarization is concerned.

### First Embodiment

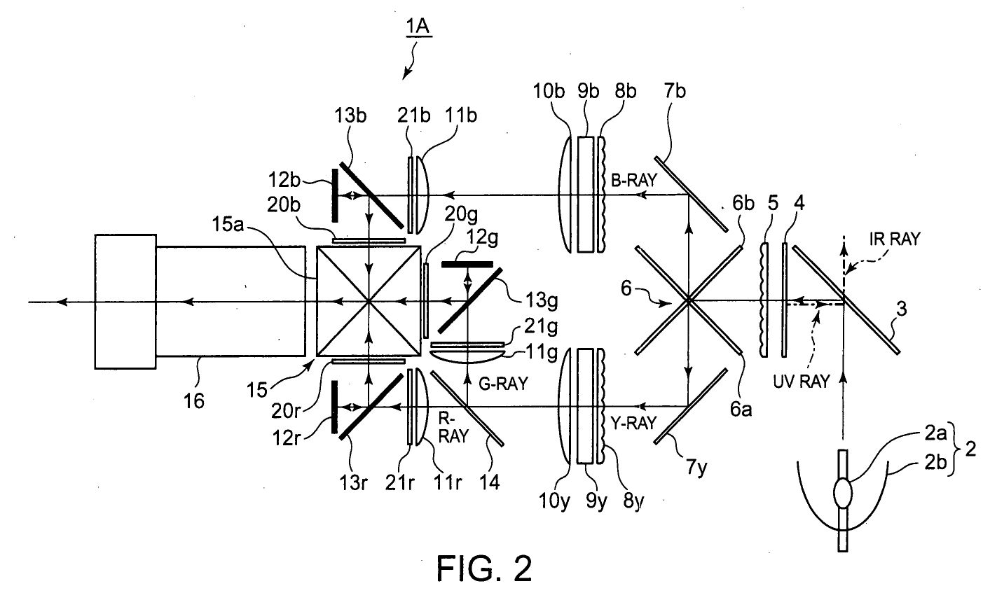

FIG. 2 shows a schematic illustration of an optical system of a projection display apparatus 1A, as a first preferred embodiment of the present invention.

As shown in FIG. 2, the optical system of the projection display apparatus 1A is equipped with: a light source 2 having a xenon lamp 2a and a concave mirror 2b; an infrared-ray pass filter 3 that allows an infrared (RF) ray to pass therethrough while reflects the other rays; an ultraviolet-ray reflection filter 4 that reflects an ultraviolet (UV) ray while allows the other rays to pass therethrough; a fly-eye lens 5 (a first lens array) that separates an incident bundle of rays into several sub-bundles of rays; and a cross dichroic mirror 6 (a first color separator) having two dichroic mirrors 6a and 6b that separate the sub-bundles of rays into sub-bundles of rays of a blue ray (referred to as a B-ray, hereinafter) and sub-bundles of rays of a yellow ray (referred to as a Y-ray, hereinafter).

Moreover, the optical system is equipped with, on the path of the sub-bundles of B-rays: a reflection mirror 7b that reflects the sub-bundles of B-rays at 90 degrees; a fly-eye lens 8b (a second lens array) that is provided at a location where the sub-bundles of rays emitted from the fly-eye lens 5 are focused onto via the cross dichroic mirror 6 and the reflection mirror 7b; a polarization converter 9b (a first polarization converter) that converts the sub-bundles of rays emitted from the fly-eye lens 8b, that are randomly polarized beams, into one type of linearly polarized beams; a condenser lens 10b that combines the sub-bundles of rays emitted from the converter 9b into a single bundle of the one type of linearly polarized beams; a field lens 11b that converts the single bundle of the one type of linearly polarized beams into telecentric light; and a reflective polarizer 13b that allows the telecentric light to pass therethrough towards a reflective liquid crystal display device 12b for B-ray and reflects the light reflected by the device 12b at 90 degrees. Provided between the field lens 11b and the reflective polarizer 13b is a polarizer 21b that is an option but preferable for higher-grade polarization-splitting characteristics of the polarizer 13b.

Moreover, the optical system is equipped with, on the path of the sub-bundles of Y-rays: a reflection mirror 7y that reflects the sub-bundles of Y-rays at 90 degrees; a fly-eye lens 8y (a third lens array) that is provided at a location where the sub-bundles of rays emitted from the fly-eye lens 5 are focused onto via the cross dichroic mirror 6 and the reflection mirror 7y; a polarization converter 9y (a second polarization converter) that converts the sub-bundles of rays emitted from the fly-eye lens 8y, that are randomly polarized beams, into one type of linearly polarized beams; a condenser lens 10y that combines the sub-bundles of rays emitted from the converter 9y into a single bundle of the one type of linearly polarized beams; and a dichrock mirror 14 (a second color separator) that separates the single bundle of the linearly polarized beams of Y-ray into a bundle of the linearly polarized beams of a green ray (referred to as a G-ray, hereinafter) and another bundle of the linearly polarized beams of a red ray (referred to as a R-ray, hereinafter)

Moreover, the optical system is equipped with, on the path of the bundle of the linearly polarized beams of G-ray: a field lens 11g that converts the bundle of the G-ray into telecentric light; and a reflective polarizer 13g that allows the telecentric light to pass therethrough towards a reflective liquid crystal display device 12g for G-ray and reflects the light reflected by the device 12g at 90 degrees. Provided between the field lens 11g and the reflective polarizer 13g is a polarizer 21g that is an option but preferable for higher-grade polarization-splitting characteristics of the polarizer 13g.

The optical system is also equipped with, on the path of the bundle of the linearly polarized beams of R-ray: a field lens 11r that converts the bundle of R-ray into telecentric light; and a reflective polarizer 13r that allows the telecentric light to pass therethrough towards a reflective liquid crystal display device 12r for R-ray and reflects the light reflected by the device 12r at 90 degrees. Provided between the field lens 11r and the reflective polarizer 13r is a polarizer 21r that is an option but preferable for higher-grade polarization-splitting characteristics of the polarizer 13r.

Furthermore, on the paths of the bundles of R-, G-, and B-rays emitted from the reflective liquid crystal display devices 12r, 12g and 12b, respectively, and reflected at 90 degrees by the reflective polarizers 13r, 13g and 13b, respectively, the optical system is equipped with: a cross dichroic prism 15 (a color combiner) that combines the bundles of R-, G-, and B-rays; and a projection lens 16 that projects the combined bundles of rays onto a screen (not shown) to display enlarged images.

Provided between the reflective polarizers 13r, 13g and 13b, and the cross dichroic prism 15 are transparent polarizers 20r, 20g and 20b, respectively, that are options but can eliminate unnecessary polarized beams from the beams of R-, G-, and B-rays reflected by the polarizers 13r, 13g and 13b, respectively.

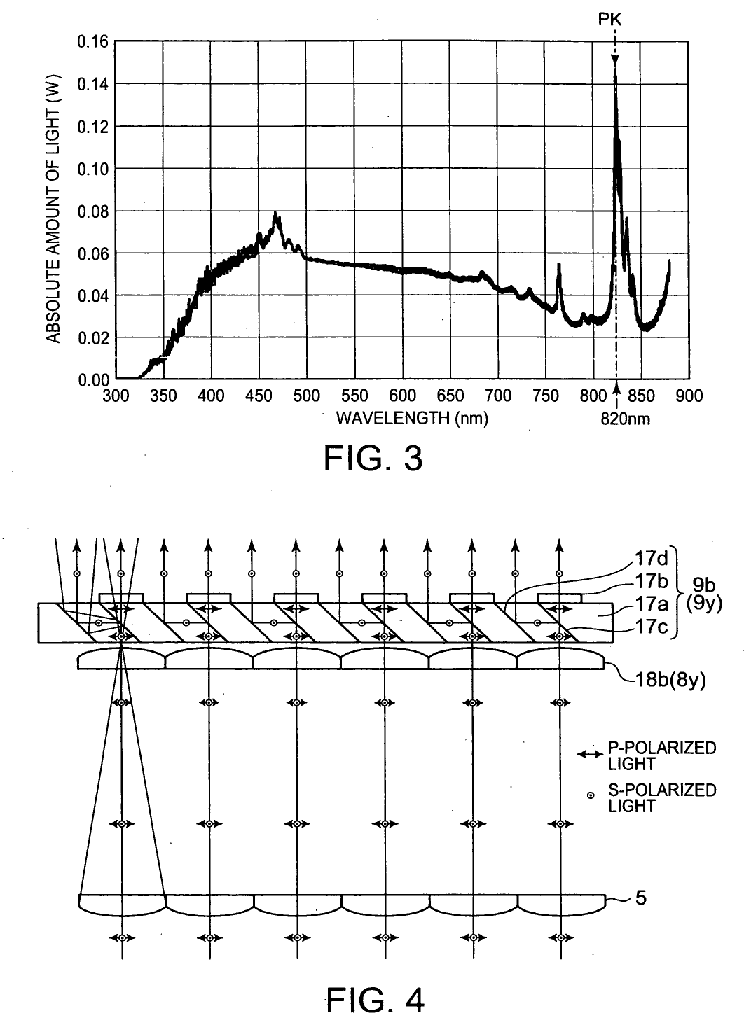

The xenon lamp 2a installed in the light source 2 for emitting light of high intensity exhibits steep bright-line spectrum (PK) at a wavelength of about 820 nm in the infrared range, as shown in FIG. 3. If an ultraviolet-/infrared-ray reflection filter is used for light that carries such a high energy in the infrared range, it allows a reflected infrared ray to return to the light source 2 to heat up the xenon lamp 2a, which may result in lower irradiance from the lamp 2a and damages to the lamp 2a due to degradation of quartz glass used for the lamp 2a.

In order to avoid such a problem, the optical system shown in FIG. 2 employs the infrared-ray pass filter 3 that does not allow an infrared ray to return to the light source 2.

Described next is the function of the optical system of the projection display apparatus 1A, shown in FIG. 2, as the first preferred embodiment of the present invention.

The light source 2 emits light to the infrared-ray pass filter 3 that is provided at an angle of 45 degrees to the optical path of the emitted light. The filter 3 allows an infrared ray of a wavelength of about 700 nm or higher of the emitted light to pass therethrough, thus the infrared ray is eliminated, whereas reflects the other rays of a wavelength of about 700 nm or lower.

The light with no infrared ray as being eliminated by the infrared-ray pass filter 3 is incident on the ultraviolet-ray reflection filter 4. The filter 4 reflects an ultraviolet ray of a wavelength of about 400 nm or shorter towards the light source 2, whereas allows the light with no infrared and ultraviolet rays thus eliminated to pass therethrough.

The bundle of rays that have passed through the ultraviolet-ray reflection filter 4 has a circular cross section in accordance with the shape of the concave mirror 2b of the light source 2. The circular bundle of rays, however, requires to be converted into a rectangular bundle of rays so that it can be efficiently incident on an effective pixel area of rectangular liquid crystal display devices.

Provided for use in such light conversion is the fly-eye lens 5 that has small rectangular convex lenses arranged in a matrix. The circular bundle of rays that have passed through the ultraviolet-ray reflection filter 4 is incident on the fly-eye lens 5 and separated into several rectangular sub-bundles of rays.

The rectangular sub-bundles of rays are incident on the cross dichroic mirror 6, by which the rays are separated into sub-bundles of B-rays having a shorter wavelength than about 490 nm and sub-bundles of Y-rays having an intermediate-to-long wavelength longer than about 490 nm.

The cross dichroic mirror 6 is constituted by two B-dichroic mirrors 6b and 6y that are provided as being inclined at 45 degrees to the direction of the rays emitted from the fly-eye lens 5 and as intersecting each other at 90 degrees.

When the sub-bundles of rays are incident on the cross dichroic mirror 6, a bundle of B-rays among those incident on the B-dichroic mirror 6b is reflected therefrom whereas a bundle of Y-rays among those incident on the B-dichroic mirror 6y is reflected therefrom. Thus, the incident sub-bundles of rays are separated into bundles of B- and Y-rays. The separated bundles of B- and Y-rays are then incident on the reflection mirrors 7b and 7y, respectively.

The bundle of B-rays that have been incident on the reflection mirror 7b provided as being inclined at 45 degrees to the direction of the incident rays are reflected therefrom at 90 degrees and incident on the fly-eye lens 8b that is provided at the focal point of the fly-eye lens 5.

An integrator optical system that includes the fly-eye lens 5 and the fly-eye lens 8b has functions of: shaping the bundle of rays emitted from the light source 2 into the shape of the reflective liquid crystal display device 12b; and achieving a uniform illuminance on the device 12b. The integrator optical system having such functions can drastically restrict irregularities, such as, color unevenness and flickers on a screen (not shown) even if a bundle of rays emitted from the light source 2 suffers such irregularities.

The B-rays emitted from the fly-eye lens 8b are randomly-polarized circular polarized beams. The randomly polarized beams of B-ray are incident on the polarization converter 9b, by which the beams are converted into one type of linearly polarized beams.

The projection display apparatus 1A of the first embodiment changes a polarization state of light beams with electric signals to use either one of p- and S-polarized beams.

For such a purpose, the polarization converter 9b has a function of turning the direction (angle) of polarization of a bundle of polarized beams by 90 degrees into another direction of polarization, as illustrated in FIG. 4. In detail, the bundle of polarized beams to be turned by 90 degrees for its direction of polarization is either of two types of bundles of linearly polarized beams that are orthogonal to each other and generated in circular-to-linear polarization conversion. The bundle of polarized beams of one type of the linearly polarized beams of no use in the projection display apparatus 1A is then turned by 90 degrees for its direction of polarization into the other type of the linearly polarized beams.

As shown in FIG. 4, the polarization converter 9b has an array of polarization beam splitters 17a and half wave plates 17b, each bonded on an S-polarized light-emitting part of the light emitting planes of the corresponding splitter 17a. The half wave plates 17b are made of materials including an organic material that exhibits birefringence. The array of polarization beam splitters 17a is constituted by several column-like transparent members, each having a parallelogram at its cross section, bonded to one another with an organic ultraviolet curable adhesive. Formed on both sides of each splitter 17a to be bonded to the next splitter 17a are a polarization beam splitting film 17c and a reflective film 17d. Each half wave plate 17b is bonded to the light emitting plane for light to pass through the polarization beam splitting film 17c of the corresponding polarization beam splitter 17a.

The function of the array of polarization beam splitters 17a is explained with reference to FIG. 4. Several sub-bundles of randomly polarized beams are incident on the array of the splitters 17a from the fly-eye lens 5 via the cross dichroic mirror 6 and reflection mirror 7b (both not shown in FIG. 4 for brevity) and the fly-eye lens 8b. S-polarized beams of the randomly polarized beams are reflected by the polarization beam splitting films 17c. In contrast, P-polarized beams of the randomly polarized beams pass through the films 17c.

The S-polarized beams reflected by the polarization beam splitting films 17c are reflected by the reflective films 17d and emitted from the array of polarization beam splitters 17a. In contrast, the P-polarized beams passing through the films 17c are turned by 90 degrees for its direction of polarization by the half wave plates 17b each bonded to the light emitting plane of the corresponding splitter 17a. The P-polarized beams turned by 90 degrees are thus converted into S-polarized beams and then emitted from the splitters 17a.

Through the mechanism of the array of polarization beam splitters 17a, all of the sub-bundles of rays emitted from the array are S-polarized beams.

If P-polarized beams are required to be emitted from the array of polarization beam splitters 17a, each half wave plate 10b can be bonded to a P-polarized light-emitting part of the corresponding reflective film 17d.

What has been described above with reference to FIG. 4 is also applied to the polarization converter 9y shown in FIG. 2.

In FIG. 2, the several sub-bundles of rays that have been converted into the S-polarized beams by the polarization converter 9b are incident on the condenser lens 10b, by which the sub-bundles of rays are combined into a single bundle of S-polarized beams.

The single bundle of S-polarized beams emitted from the condenser lens 10b are incident on the field lens 11b, by which the bundle of rays are refracted in accordance with the size of an display area of the reflective liquid crystal display device 12b for B-ray. The refracted bundle of rays then pass through the reflective polarizer 13b provided as being inclined at 45 degrees to the light path and are incident on the display device 12b.

The reflective polarizer 13b has a reflective plane that is formed with multiple metallic films of, such as aluminum, arranged in a stripe on an optical glass at, for example, about 40 nm intervals. The polarizer 13b allows polarized beams, such as, S-polarized beams, incident thereon as being perpendicular to the metallic films, to pass therethrough. In contrast the polarizer 13b reflects polarized beams, such as, P-polarized beams, incident thereon as being parallel to the metallic films.

The reflective polarizer 13b is a polarization splitter shaped in a plate and constituted by an optical glass and metallic films with no organic materials being included. Thus, the polarizer 13b hardly absorbs light from the light source 1, and hence restricts decrease in quality of projected images which otherwise occurs due to birefringence.

What has been described above for the reflective polarizer 13b is also applied to the reflective polarizers 13r and 13g shown in FIG. 2.

Described so far is the function of the optical system of the projection display apparatus 1A to the sub-bundles of B-rays separated and emitted from the cross dichroic mirror 6. The same description is basically applied to the sub-bundles of Y-rays separated and emitted from the cross dichroic mirror 6.

The sub-bundles of Y-rays separated and emitted from the cross dichroic mirror 6 are incident on the reflection mirror 7y provided as being inclined at 45 degrees to the direction of the incident rays. The sub-bundles of Y-rays are then reflected therefrom at 90 degrees and incident on the fly-eye lens 8y that is provided at the focal point of the fly-eye lens 5.

The sub-bundles of Y-rays are emitted from the fly-eye lens 8y and then incident on the polarization converter 9y. The Y-rays, or randomly-polarized circular polarized beams, are converted by the converter 9b into S-polarized beams.

The sub-bundles of Y-rays converted into the S-polarized beams are incident on the condenser lens 10y, by which the sub-bundles of rays are combined into a single bundle of S-polarized beams.

The bundle of S-polarized beams emitted from the condenser lens 10y is incident on the dichrock mirror 14 that reflects a G-ray whereas allows a R-ray to pass therethrough. The bundle of S-polarized beams are then separated into a bundle of S-polarized beams of G-ray and another bundle of S-polarized beams of R-ray.

The bundles of S-polarized beams of G- and R-rays are then incident on the field lenses 11g and 11r, respectively, by which the beams of G- and R-rays are refracted in accordance with the size of an display area of the reflective liquid crystal display devices 12g for G-ray and 12r for R-ray, respectively.

The refracted beams of G- and R-rays then pass through the reflective polarizers 13g and 13r, respectively, each provided as being inclined at 45 degrees to the light path. The refracted beams of G- and R-rays are then incident on the reflective liquid crystal display devices 12g for G-ray and 12r for R-ray, respectively.

Drive voltages generated based on video signals for the colors R, G and B are applied to liquid crystals of the reflective liquid crystal display devices 12r for R-ray, 12g for G-ray and 12b for B-ray, respectively.

The bundles of R-, G- and B-rays that have been reflected and modulated by the reflective liquid crystal display devices 12r for R-ray, 12g for G-ray and 12b for B-ray, respectively, are then reflected at the reflective polarizers 13r, 13g and 13b, respectively, so that their optical paths are bent by 90 degrees.

The path-bent bundles of R-, G- and B-rays are then incident on the cross dichroic prism 15 at three light incident planes (not a light emitting plane 15a). The bundles of R-, G- and B-rays are combined into a bundle of R-, G- and B-rays by the prism 15 and emitted therefrom. The emitted bundle of R-, G- and B-rays are enlarged by the projection lens 16 and then projected onto a screen (not shown) to display enlarged images.

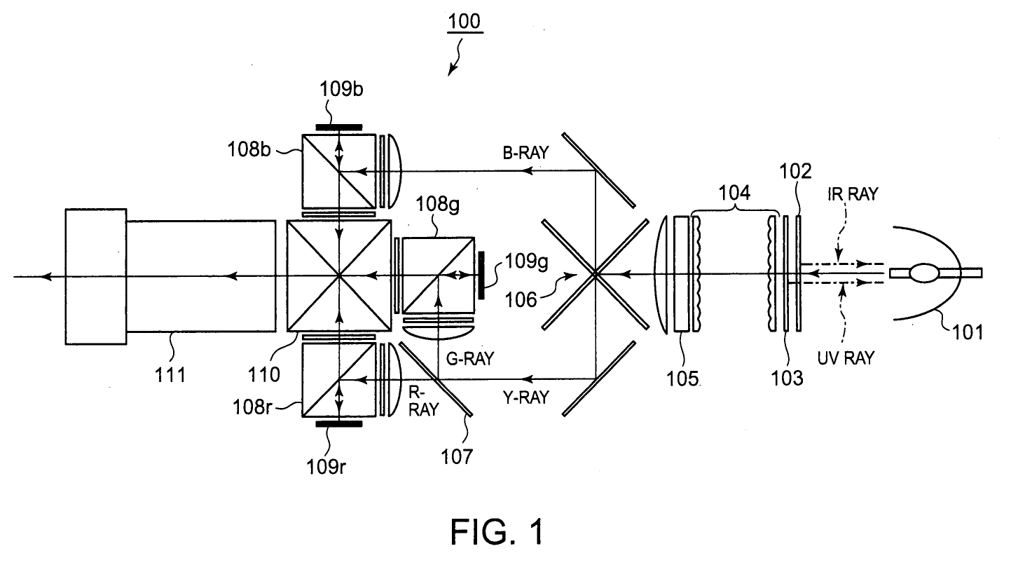

Advantageous features of the projection display apparatus 1A shown in FIG. 2 (the first embodiment of the present invention) are discussed in relation to the known projection display apparatus 100 shown in FIG. 1.

In FIG. 1, light emitted from the light source 101 is incident on the polarization converter 105 via the fly-eye lens system 104, as white light, after the infrared and ultraviolet rays are eliminated by the infrared- and ultraviolet-ray reflection filters 102 and 103, respectively.

In contrast in FIG. 2, light emitted from the light source 2 is separated into B- and Y-rays via the fly-eye lens 5 and incident on the polarization converters 9b and 9y, respectively, provided on the optical paths of B-ray (in a short wavelength range) and Y-ray (in a long wavelength range), respectively, after the infrared and ultraviolet rays are eliminated through the infrared-ray pass filter 3 and ultraviolet-ray reflection filter 4, respectively.

Therefore, compared to the polarization converter 105 shown in FIG. 1, the polarization converters 9b and 9y for B- and Y-rays, respectively, shown in FIG. 2 are exposed to lower optical energy. In detail, the adhesive used for bonding the half wave plates 17b made with an organic material and the polarization beam splitters 17a to each other that constitute the polarization converters 9b and 9y, as shown in FIG. 4, suffer lower optical energy than those of the polarization converter 105.

The light to be incident on the polarization converters 9b and 9y for B- and Y-rays, respectively, are those in a low and a long wavelength range only, respectively,

Accordingly, the optical and also thermal loads to be applied to the organic material used for the half wave plates 17b of the polarization converters 9b and 9y are smaller than those applied to the organic material used for the half wave plate of the polarization converter 105.

Such smaller optical and thermal loads allow the projection display apparatus 1A to use the light source 2 of higher intensity than the known projection display apparatus 100, with a longer life due to smaller decrease in the optical characteristics.

Moreover, the projection display apparatus 1A has two separated optical systems for B- and Y-rays: one constituted by the fly-eye lens 8b, the polarization converter 9b and the condenser lens 10b; and the other, the fly-eye lens 8y, the polarization converter 9y and the condenser lens 10y.

The light to be incident on the separated polarization converters 9b and 9y are thus those in a narrower B-wavelength range. This allows a higher freedom of design to the polarization beam splitting films 17c (FIG. 4) for an excellent spectral characteristics, which further allows chromaticity points of R-, G- and B-rays to be allocated on a desired chromaticity diagram to achieve a wider range of color reproduction.

Moreover, in the projection display apparatus 1A of the first embodiment shown in FIG. 2, the light having irregularities is incident on the two integrator optical systems (one having the fly-eye lenses 5 and 8b, and the other, the fly-eye lenses 5 and 8y) from the light source 2, after color separation. The incident light is then separated into bundles of rays of different irregularities though the two integrator optical systems. The bundles of rays that exhibit different irregularities are, however, combined by the cross dichroic prism 15 to have less irregularities, thus producing high-quality images on a screen (not shown) when projected thereonto.

### Second Embodiment

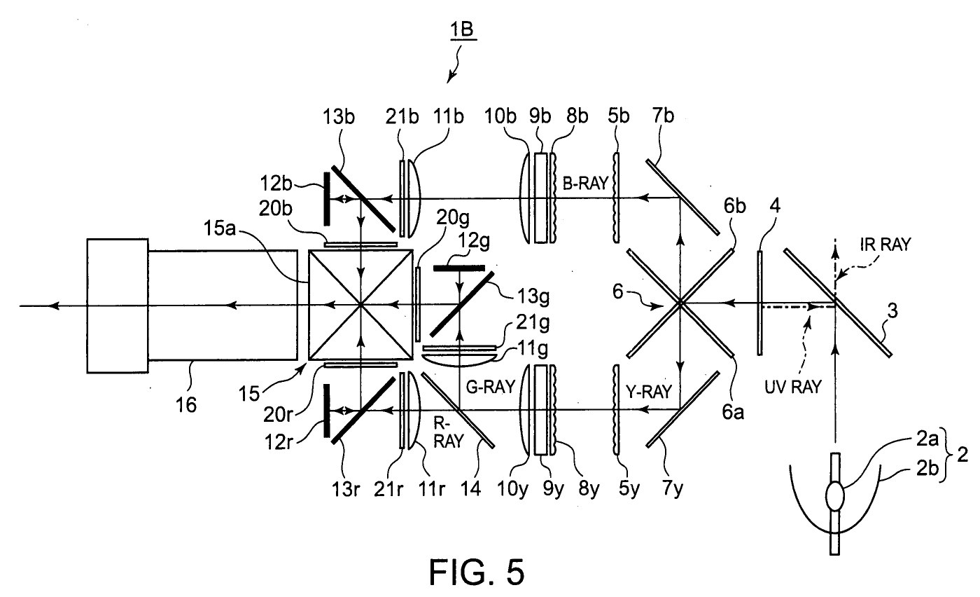

FIG. 5 shows a schematic illustration of an optical system of a projection display apparatus 1B, as a second preferred embodiment of the present invention.

The same reference numerals or signs are given to the elements of FIG. 5 that are identical or analogous to those of FIG. 2, the detailed explanation thereof being omitted for brevity.

As shown in FIG. 5, the optical system of the projection display apparatus 1B is equipped with a fly-eye lens 5b for B-ray in front of the fly-eye lens 8b and a fly-eye lens 5y for Y-ray in front of the fly-eye lens 8y, instead of the fly-eye lens 5 shown in FIG. 2.

The fly-eye lenses 5b and 8b constitute a first integrator optical system. The fly-eye lenses 5y and 8y constitute a second integrator optical system.

The light emitted from the light source 2 is incident on the cross dichroic mirror 6 (a first color separator) after infrared (RF) and ultraviolet (UV) rays are eliminated by the infrared-ray pass filter 3 and ultraviolet-ray reflection filter 4, respectively. The light incident on the cross dichroic mirror 6 is separated into a bundle of B-rays and another bundle of Y-rays. The bundles of B- and Y-rays are then reflected by 90 degrees at the reflection mirrors 7b and 7y, respectively.

The reflected bundles of B- and Y-rays are incident on the fly-eye lenses 5b and 5y, respectively, by which each is separated into several rectangular sub-bundles of rays. The sub-bundles of rays are then incident on the fly-eye lenses 8b and 8y, respectively, which are provided on the focal points of the fly-eye lenses 5b and 5y, respectively. The sub-bundles of rays emitted from the fly-eye lenses 8b and 8y are incident on the polarization converters 9b and 9y (a first and a second polarization converter, respectively), by which the rays are converted from randomly polarized beams into S-polarized beams. One set of S-polarized sub-bundles of rays are combined into a single bundle of S-polarized beams by the condenser lens 10b and emitted therefrom. The other set of S-polarized sub-bundles of rays are combined into a single bundle of S-polarized beams by the condenser lens 10y and emitted therefrom.

The rays emitted from the condenser lenses 10b and 10y are applied the same procedures as described with reference to FIG. 2, and hence the explanation thereof is omitted for brevity.

The fly-eye lenses 5b and 8b, and 5y and 8y can be designed to have optimum curvature for their multiple convex lenses, for B- and Y-rays, respectively, which provides a uniform illuminated area to the reflective liquid crystal display devices 12r, 12g and 12b for the colors R, G and B, respectively. This is an advantage of the second embodiment in addition to those discussed with respect to the first embodiment.

Moreover, compared to the first embodiment (FIG. 2), the second embodiment achieves shorter focal lengths from the optical integrator systems (fly-eye lenses 5b and 8b, and 5y and 8y) to the reflective liquid crystal display devices 12r, 12g and 12b for the colors R, G and B, respectively, which results in compactness for the optical integrator systems, and hence the entire optical system.

### Third Embodiment

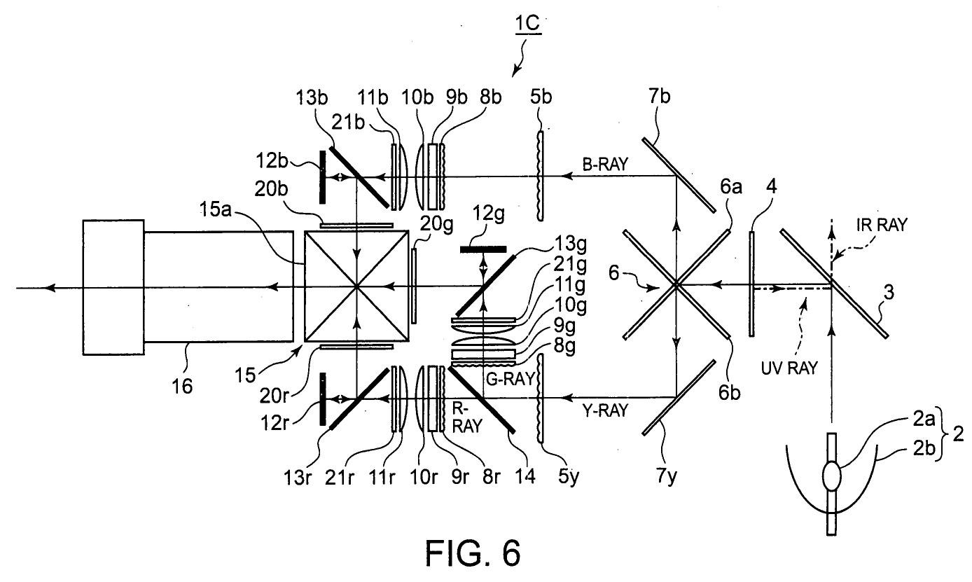

FIG. 6 shows a schematic illustration of an optical system of a projection display apparatus 1C, as a third preferred embodiment of the present invention.

The same reference numerals or signs are given to the elements of FIG. 6 that are identical or analogous to those of FIGS. 2 and 5, the detailed explanation thereof being omitted for brevity.

As shown in FIG. 6, the optical system of the projection display apparatus 1C is equipped with: three integrator optical systems of fly-eye lenses (5b, 8b), (5y, 8g) and (5y, 8r) for B-, G- and R-rays, respectively; three polarization converters 9b, 9g and 9y for B-, G- and R-rays, respectively; and also three condenser lenses 10b, 10g and 10r for B-, G- and R-rays, respectively.

The light emitted from the light source 2 is incident on the cross dichroic mirror 6 (a first color separator) after infrared (RF) and ultraviolet (UV) rays are eliminated by the infrared-ray pass filter 3 and ultraviolet-ray reflection filter 4, respectively. The light incident on the cross dichroic mirror 6 is separated into a bundle of B-rays and another bundle of Y-rays. The bundles of B- and Y-rays are then reflected by 90 degrees at the reflection mirrors 7b and 7y, respectively.

The reflected bundles of B- and Y-rays are incident on the fly-eye lenses 5b and 5y, respectively, by which each is separated into several rectangular sub-bundles of rays. The sub-bundles of Y-rays thus separated by the fly-eye lens 5y are incident on the dichrock mirror 14 (a second color separator), by which they are separated further into sub-bundles of rays of R- and G-rays.

The sub-bundles of B-ray thus separated by the fly-eye lens 5b (a first lens array) are incident on the fly-eye lens 8b (a second lens array) which is provided on the focal point of the fly-eye lens 5b. The sub-bundles of R- and G-rays thus separated by the dichrock mirror 14 are incident on the fly-eye lens 8r (a fourth lens array) and the fly-eye lens 8g (a fifth lens array), respectively, each being provided on the focal point of the fly-eye lens 5y (a third lens array) via the dichrock mirror 14.

The sub-bundles of rays emitted from the fly-eye lens 8b are incident on the polarization converter 9b (a first polarization converter), by which the rays are converted from randomly polarized beams into S-polarized beams. The sub-bundles of rays emitted from the fly-eye lenses 8r and 8g are incident on the polarization converters 9r and 9g (a second and a third polarization converter, respectively), respectively, by which the rays are converted from randomly polarized beams into S-polarized beams. The S-polarized sub-bundles of beams are emitted from the condenser lenses 10r, 10g and 10b, respectively, and incident on the field lenses 11r, 11g and 11b, respectively, by which the bundles of rays are refracted in accordance with the size of the display areas of the reflective liquid crystal display device 12r, 12g and 12b for R-, G- and B-rays, respectively.

The rays emitted from the field lenses 11r, 11g and 11b are applied the same procedures as described with reference to FIG. 2, and hence the explanation thereof is omitted for brevity.

Advantageous features of the projection display apparatus 1C shown in FIG. 6 (the third embodiment) are also discussed in relation to the known projection display apparatus 100 shown in FIG. 1.

In FIG. 1, as already discussed, light emitted from the light source 101 is incident on the polarization converter 105 via the fly-eye lens system 104, as white light, after the infrared and ultraviolet rays are eliminated by the infrared- and ultraviolet-ray reflection filters 102 and 103, respectively.

In contrast in FIG. 6, light emitted from the light source 2 is separated into B-ray via the fly-eye lenses 5b and 8b, and G- and R-rays via the fly-eye lenses 5y, 8g and 8r, and incident on the polarization converters 9b, 9g and 9r provided on the optical paths of B-ray (in a short wavelength range), G-ray (in an intermediate range between short and long wavelength ranges) and R-ray (in a long wavelength range), respectively, after the infrared and ultraviolet rays are eliminated through the infrared-ray pass filter 3 and ultraviolet-ray reflection filter 4, respectively.

Therefore, compared to the polarization converter 105 shown in FIG. 1, the polarization converters 9b, 9g and 9r for B- G- and R-rays, respectively, shown in FIG. 6 are exposed to lower optical energy. In detail, the adhesive used for bonding the half wave plates 17b made with an organic material and the polarization beam splitters 17a to each other that constitute the polarization converters 9b, 9g and 9r, as shown in FIG. 4 suffer lower optical energy than those of the polarization converter 105.

The light to be incident on the polarization converters 9b and 9r for B- and R-rays, respectively, are those in a low and a long wavelength range only, respectively,

Accordingly, the optical and also thermal loads to be applied to the organic material used for the half wave plates 17b of the polarization converters 9b and 9y are smaller than those applied to the organic material used for the half wave plate of the polarization converter 105.

Such smaller optical and thermal loads allow the projection display apparatus IC to use the light source 2 of higher intensity than the known projection display apparatus 100, with a longer life due to smaller decrease in the optical characteristics.

Moreover, the projection display apparatus 1C has three separated optical systems for R- G- and B-rays: one constituted by the fly-eye lens 8r, the polarization converter 9r and the condenser lens 10r; the other, the fly-eye lens 8g, the polarization converter 9g and the condenser lens 10g; and still the other, the fly-eye lens 8b, the polarization converter 9b and the condenser lens 10b.

The light to be incident on the separated polarization converters 9r, 9g and 9b are thus those in a narrower wavelength range. This allows a higher freedom of design to the polarization beam splitting films 17c (FIG. 4) for an excellent spectral characteristics, which further allows chromaticity points of R-, G- and B-rays to be allocated on a desired chromaticity diagram to achieve a wider range of color reproduction.

Moreover, in the projection display apparatus 1C of the third embodiment shown in FIG. 6, the light having irregularities is incident on the three integrator optical systems (one having the fly-eye lenses 5b and 8b, the other, the fly-eye lenses 5y and 8g, and still the other, the fly-eye lenses 5y and 8r) from the light source 2, after color separation. The incident light is then separated into bundles of rays of different irregularities through the three integrator optical systems. The bundles of rays that exhibit different irregularities are, however, combined by the cross dichroic prism 15 to have less irregularities, thus producing higher-quality images, than the first embodiment, on a screen (not shown) when projected thereonto.

Furthermore, the third embodiment is provided with three integrator optical systems. This is because, a larger number of integrator optical systems achieves decrease in difference in the imaging characteristics caused by chromatic aberration due to difference in wavelength. Moreover, the fly-eye lenses 5b and 8b, 5y and 8g, and 5y and 8r of the three integrator optical systems can be designed to have optimum curvature for their multiple convex lenses, for B- G- and R-rays, respectively, which provides a uniform illuminated area to the reflective liquid crystal display devices 12b, 12g and 12r for the colors B, G and R, respectively. This is more advantageous for the third embodiment than the second embodiment.

Moreover, the third embodiment achieves shorter focal lengths from the optical integrator systems (fly-eye lenses 5b and 8b, 5y and 8g, and 5y and 8r) to the reflective liquid crystal display devices 12b, 12g and 12r for the colors B, G and R, respectively, which results in further compactness for the optical integrator systems, and hence the entire optical system.

### Fourth Embodiment

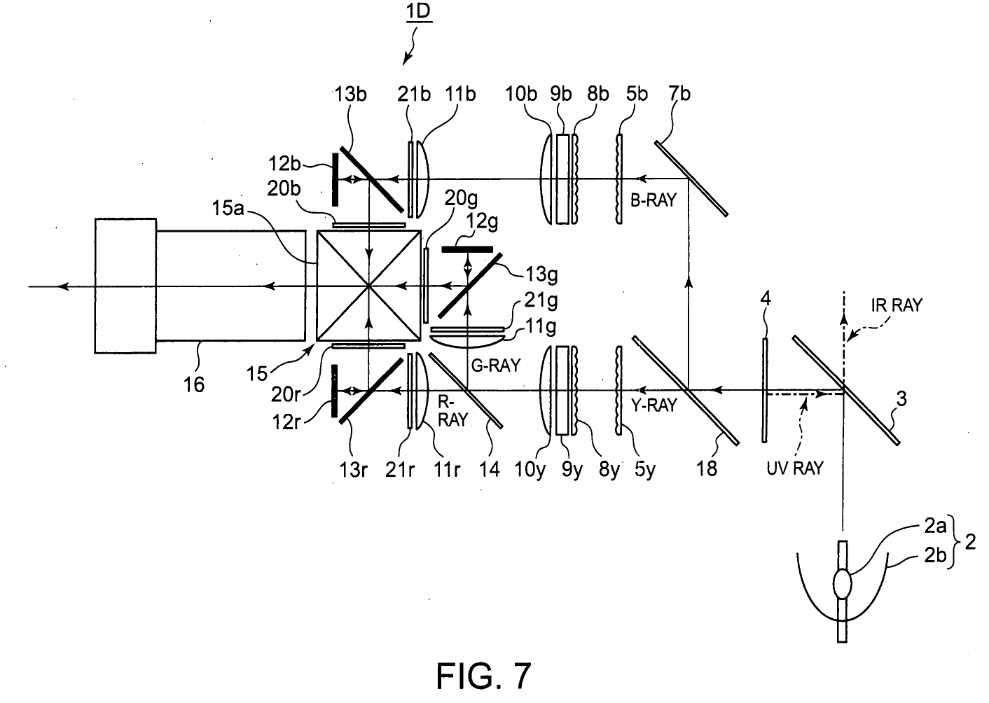

FIG. 7 shows a schematic illustration of an optical system of a projection display apparatus 1D, as a fourth preferred embodiment of the present invention.

The same reference numerals or signs are given to the elements of FIG. 7 that are identical or analogous to those of FIGS. 2 and 5, the detailed explanation thereof being omitted for brevity.

As shown in FIG. 7, the optical system of the projection display apparatus 1D is equipped with a dichroic mirror 18, different from the second embodiment shown in FIG. 5. The dichroic mirror 18 has a function of reflecting a bundle of B-rays whereas allowing a bundle of Y-rays to pass therethrough.

The light emitted from the light source 2 is incident on the cross dichroic mirror 18 after infrared (RF) and ultraviolet (UV) rays are eliminated by the infrared-ray pass filter 3 and ultraviolet-ray reflection filter 4, respectively. The light incident on the cross dichroic mirror 18 is separated into a bundle of B-rays and another bundle of Y-rays. The bundle of B-ray is only reflected by 90 degrees at the reflection mirror 7b and then incident on the integrator optical system of the fly-eye lenses 5b and 8b. In contrast, the bundle of Y-ray is directly incident on the other integrator optical system of the fly-eye lenses 5y and 8y.

The rays emitted from the fly-eye lenses 8b and 8y are applied the same procedures as described with reference to FIG. 5, and hence the explanation thereof is omitted for brevity.

The dichroic mirror 18 reflects a bundle of B-rays whereas allows a bundle of Y-rays to pass therethrough, in FIG. 7. The mirror 18 may, however, be arranged so that it can reflect Y-rays whereas allow B-rays to pass therethrough, with the reflection mirror 7y being provided on the path of light emitted from the ultraviolet-ray reflection filter 4, such as shown in FIG. 5.

Moreover, the dichroic mirror 18 may be provided, instead of the cross dichroic mirror 6, with the reflection mirror 7b or 7y, in the second and third embodiments shown in FIGS. 5 and 6, respectively.

Installation of the dichroic mirror 18 instead of the cross dichroic mirror 6 allows a simpler construction to the optical system and also provides a straight optical path to the reflective liquid crystal display device 12r from the light source 2, which achieves higher light utilization efficiency, with almost no displacement of optical axis and color unevenness or irregularity, on a screen.

### Fifth Embodiment

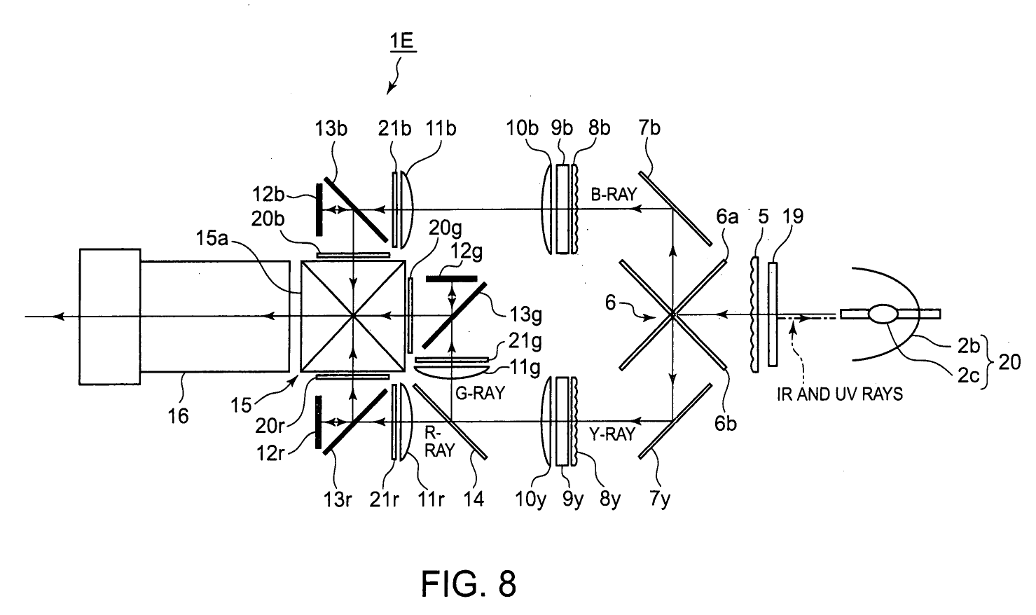

FIG. 8 shows a schematic illustration of an optical system of a projection display apparatus 1E, as a fifth preferred embodiment of the present invention.

The same reference numerals or signs are given to the elements of FIG. 8 that are identical or analogous to those of FIG. 2, the detailed explanation thereof being omitted for brevity.

In FIG. 8, the optical system of the projection display apparatus 1E is equipped with a light source 20 having an extra-high pressure mercury lamp 2c and a concave mirror 2b, and an infrared- and ultraviolet-ray reflection filter 19 instead of the infrared-ray pass filter 3 and ultraviolet-ray reflection filter 4 shown in FIG. 2.

The extra-high pressure mercury lamp 2c, installed in the optical system of the projection display apparatus 1E and relatively popular for projectors, exhibits light intensity that is not so high compared to the xenon lamp 2a shown in FIG. 2. However, the absolute amount of infrared rays that return to the light source 2 after reflected by the infrared- and ultraviolet-ray reflection filter 19 is smaller. Thus, the extra-high pressure mercury lamp 2c suffers a smaller decrease in irradiance and less damage due to degradation of quarts used in the lamp 2c.

In the projection display apparatus 1E having the extra-high pressure mercury lamp 2c, the light emitted from the light source 20 is incident on the infrared- and ultraviolet-ray reflection filter 19, by which both of the infrared (RF) and ultraviolet (UV) rays are eliminated. The infrared/ultraviolet-ray-eliminated light is then incident on the fly-eye lens 5 and separated into several rectangular sub-bundles of rays.

The rays emitted from the fly-eye lens 5 are applied the same procedures as described with reference to FIG. 2, and hence the explanation thereof is omitted for brevity.

The infrared- and ultraviolet-ray reflection filter 19 provides a straight optical path in the infrared/ultraviolet-ray eliminating optical system for eliminating infrared and ultraviolet rays, which achieves higher light utilization efficiency, with almost no displacement of optical axis and color unevenness or irregularity, on a screen.

Moreover, the infrared- and ultraviolet-ray reflection filter 19 provides a smaller optical system than the infrared-ray pass filter 3 and ultraviolet-ray reflection filter 4, such as shown in FIG. 2. Because the filter 19 does not need to be provided like the filter 3 that has to be provided at an angle of 45 degrees to the optical path of the light emitted from the light source 2, such as shown in FIG. 2.

The infrared- and ultraviolet-ray reflection filter 19 may also be installed in the projection display apparatuses of the other embodiments, instead of the infrared-ray pass filter 3 and ultraviolet-ray reflection filter 4.

Throughout the five embodiments described above, polarization beam splitters can be used instead of the reflective polarizers 13r, 13g and 13b. Moreover, transmissive liquid crystal display devices can be used instead of the reflective liquid crystal display devices 12r, 12g and 12b.

Several advantages of the projection display apparatus according to the present invention will be explained below.

In each embodiment, the polarization converters 9b and 9y (9r) are provided on the optical paths of bundles of rays separated by the cross dichroic mirror 6 or the dichroic mirror 18.

In such arrangements, the absolute amount of light of each separated bundle of rays becomes smaller than the rays before separated, which allows the polarization converters 9b and 9y (9r) to extend life.

Moreover, in such arrangements, rays are separated by the cross dichroic mirror 6 or the dichroic mirror 18 into specific wavelength ranges before being incident on the polarization converters 9b and 9y (9r). Such optical separation allows the polarization converters to exhibit higher reliability. This is because the optical and thermal energies in shorter and longer wavelengths, respectively, (which are major factors in determining the reliability) of the rays are optically separated before being incident on the polarization converters.

The light to be incident on the polarization converters 9b and 9y (9r) are those in specific narrow wavelength ranges after separated by the cross dichroic mirror 6 or the dichroic mirror 18, as already discussed. This allows a higher freedom of design to the polarization beam splitting films 17c (FIG. 4) of each polarization converter for an excellent spectral characteristics, which further allows chromaticity points of R-, G- and B-rays to be allocated on a desired chromaticity diagram to achieve a wider range of color reproduction.

Moreover, the fly-eye lenses included in the several integrator optical systems can be designed to have optimum curvature for their multiple convex lenses, for specific wavelength ranges. Such design provides a uniform illuminated area to the reflective liquid crystal display devices for the colors R, G and B, respectively.

Furthermore, in the embodiments, light having irregularities is incident on the several integrator optical systems, after color separation, by which it is converted into separated bundles of rays of different irregularities. The bundles of rays that exhibit different irregularities are then combined by the cross dichroic prism to have less irregularities, thus providing higher-quality images on a screen.

Moreover, in the embodiments, each polarization converter can be provided as closer to the associated reflective liquid crystal display device, which allows compactness for the associated integrator optical system and hence the entire optical system of the projection display apparatus.

What is claimed is:

1. A projection display apparatus comprising:
a light source to emit a bundle of rays;
a first lens array via which the bundle of rays is converted into a plurality of sub-bundles of rays;
a first color separator to separate the sub-bundles of rays emitted from the first lens array into first and second sub-bundles of rays of a first and a second color, respectively, the first and second sub-bundles of rays being emitted in different directions;
a second and a third lens array via which the first and the second sub-bundles of rays are combined into a first and a second bundle of rays of uniform illuminance, respectively;
a first and a second polarization converter to apply polarization beam splitting and then polarization angle conversion to the first and second bundle of rays of uniform illuminance, respectively, to convert the first and second bundle of rays of uniform illuminance into first and second linearly polarized beams, respectively;
a second color separator, provided on an optical path of the second linearly polarized beams, to separate the second linearly polarized beams into third and fourth linearly polarized beams of different colors, the third and fourth linearly polarized beams being emitted in different directions;
liquid crystal display devices, provided on optical paths of the first, third and fourth linearly polarized beams, respectively, to modulate the first, third and fourth linearly polarized beams with input video signals into first, second and third modulated beams, respectively; and
a color combiner to combine the first, second and third modulated beams into a combined bundle of rays to be projected for displaying images carried by the video signals.

2. The projection display apparatus according to claim 1, wherein the first color separator reflects sub-bundles of rays emitted from the first lens array and related to one of the first and second colors whereas allows sub-bundles of rays emitted from the first lens array and related to the other color to pass therethrough as the first and second sub-bundles of rays of the first and second colors, respectively, either of the first or the second sub-bundles of rays emitted from the first color separator having a straight optical path to at least one of the liquid crystal display devices.

3. A projection display apparatus comprising:
a light source to emit a bundle of rays;
a first color separator to separate the bundle of rays emitted from the light source into first and second bundle of rays of a first and a second color, respectively, the first and second bundle of rays being emitted in different directions;
a first and a second integrator optical system via which the first and the second bundle of rays are processed as exhibiting uniform illuminance;
a first and a second polarization converter to apply polarization beam splitting and then polarization angle conversion to the first and second bundle of rays of uniform illuminance, respectively, to convert the first and second bundle of rays of uniform illuminance into first and second linearly polarized beams, respectively;
a second color separator, provided on an optical path of the second linearly polarized beams, to separate the second linearly polarized beams into third and fourth linearly polarized beams of different colors, the third and fourth linearly polarized beams being emitted in different directions;
liquid crystal display devices, provided on optical paths of the first, third and fourth linearly polarized beams, respectively, to modulate the first, third and fourth linearly polarized beams with input video signals into first, second and third modulated beams, respectively; and
a color combiner to combine the first, second and third modulated beams into a combined bundle of rays to be projected for displaying images carried by the video signals.

4. The projection display apparatus according to claim 3, wherein the first color separator reflects sub-bundles of rays emitted from the first lens array and related to one of the first and second colors whereas allows sub-bundles of rays emitted from the first lens array and related to the other color to pass therethrough as the first and second sub-bundles of rays of the first and second colors, respectively, either of the first or the second sub-bundles of rays emitted from the first color separator having a straight optical path to at least one of the liquid crystal display devices.

5. A projection display apparatus comprising:
a light source to emit a bundle of rays;
a first color separator to separate the bundle of rays emitted from the light source into first and second bundle of rays of a first and a second color, respectively, the first and second bundle of rays being emitted in different directions;
a first lens array, provided on an optical path of the separated first bundle of rays, via which the separated first bundle of rays is converted into a plurality of first sub-bundles of rays;
a second lens array, provided on an optical path of the first sub-bundle of rays, via which the first sub-bundles of rays are combined into a first bundle of rays of uniform illuminance;
a first polarization converter, provided on an optical path of the first bundle of rays of uniform illuminance, to apply polarization beam splitting and then polarization angle conversion to the first bundle of rays of uniform illuminance to convert the first bundle of rays of uniform illuminance into first linearly polarized beams;
a first liquid crystal display device, provided on an optical path of the first linearly polarized beams, to modulate the first linearly polarized beams with input video signals into first modulated beams;
a third lens array, provided on an optical path of the separated second bundle of rays, via which the separated second bundle of rays is converted into a plurality of second sub-bundles of rays;
a second color separator, provided on an optical path of the second sub-bundles of rays, to separate the second sub-bundle of rays into third and fourth bundle of rays of different colors, the third and fourth bundle of rays being emitted in different directions;
a fourth and a fifth lens array, provided on optical paths of the third and fourth bundle of rays, respectively, via which the third and fourth sub-bundles of rays are combined into a third and a fourth bundle of rays of uniform illuminance, respectively;
a second and a third polarization converter, provided on optical paths of the third and fourth bundle of rays of uniform illuminance, respectively, to apply polarization beam splitting and then polarization angle conversion to the third and fourth bundle of rays of uniform illuminance, respectively, to convert the third and fourth bundle of rays of uniform illuminance into third and fourth linearly polarized beams, respectively;
a second and a third crystal display device, provided on optical paths of the third and fourth linearly polarized beams, respectively, to modulate the third and fourth linearly polarized beams with input video signals into second and third modulated beams, respectively; and
a color combiner to combine the first, second and third modulated beams into a combined bundle of rays to be projected for displaying images carried by the video signals.

6. The projection display apparatus according to claim 5, wherein the first color separator reflects sub-bundles of rays emitted from the first lens array and related to one of the first and colors whereas allows sub-bundles of rays emitted from the first lens array and related to the other color to pass therethrough as the first and second sub-bundles of rays of the first and second colors, respectively, either of the first or the second sub-bundles of rays emitted from the first color separator having a straight optical path to at least one of the liquid crystal display devices.
